(19) United States
(12) Patent Application Publication
(10) Pub. No.: US 2010/0126526 A1
(43) Pub. Date: May 27, 2010

(54) Safety arrangement for a dishwasher

(75) Inventors: Dennis A. Poyner, Kinston, NC (US); Ashwin Jadhav, New Bern, NC (US); David Sumner, Greenville, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc

(21) Appl. No.: 12/275,918

(22) Filed: Nov. 21, 2008

(51) Int. Cl. B08B 7/04; B08B 3/04

(52) U.S. Cl. 134/18; 134/56 D

(57) ABSTRACT

Provided is a safety arrangement for a dishwasher. The safety arrangement may include a rack sensing component configured to determine whether a rack is in a washing location in a dishwasher and to provide a signal in response thereto. A processing unit may be in communication with the rack sensing component and may be configured to receive the signal. The processing unit may be further configured to prevent a washing procedure of the dishwasher when the signal indicates that the rack is not disposed in the washing location. The dishwasher may further include a user interface in communication with the processing unit, which user interface can provide an indicia of the rack not being disposed in the washing location and/or may be rendered inoperable by the processing unit when the signal indicates that the rack is not disposed in the washing location.

### FIELD OF THE INVENTION

The present invention relates to dishwashers and, more particularly, to dishwashers including safety arrangements for determining whether a rack is present in a washing chamber of a dishwasher.

### BACKGROUND

Most dishwashers include a washing chamber into which items may be loaded for washing, usually with detergent and hot water. Often, dishwashers include racks that can be moved out of the washing chamber to facilitate loading of items to be washed and then moved into the chamber for washing.

As it is, the dimensions of many washing chambers are such that the chamber is capable of accommodating a small child, and one must be careful to assure that children do not become accidentally trapped within the washing chamber, especially during a wash cycle, which could result in injury to or even death of the child. When a rack is present in the chamber, the rack tends to block access to the chamber. However, there is always a possibility that a small child may remove the lower rack of a dishwasher and enter the resulting empty space within the unit, and therefore be exposed to the hazards associated therewith.

### SUMMARY

In one aspect, a safety arrangement for a dishwasher is provided. The safety arrangement may include a rack sensing component configured to determine whether a rack is in a washing location in a dishwasher and to provide a signal in response thereto. A processing unit may be in communication with the rack sensing component and may be configured to receive the signal. The processing unit may be further configured to prevent a washing procedure of the dishwasher when the signal indicates that the rack is not disposed in the washing location. The dishwasher may include a water inlet valve in communication with the processing unit, and the processing unit may be configured to prevent opening of a water inlet valve when the signal indicates that the rack is not disposed in the washing location. The dishwasher may further include a user interface in communication with the processing unit. The user interface can be configured to provide an indicia of the rack not being disposed in the washing location in response to the signal, and/or may be rendered inoperable by the processing unit when the signal indicates that the rack is not disposed in the washing location.

In one embodiment, the rack sensing component may be configured to physically engage the rack when the rack is disposed at the washing location. In such case, the determination as to whether the rack is in the washing location involves the rack sensing component sensing physical engagement with the rack. The rack sensing component may define an incomplete electrical circuit configured to be completed by the rack when the rack is disposed in the washing location, for example, by urging a switch into a closed position to complete the electrical circuit. In another embodiment, the rack sensing component may include a detection device configured to detect the rack and a disposition thereof with respect to the washing location.

In another aspect, a dishwasher is provided that includes a washing chamber defining therein a washing location. A rack may be disposed within and selectively removable from the washing chamber. A washing mechanism may be configured to dispense fluid into the washing chamber. The dishwasher may further include a safety arrangement including a rack sensing component and a processing unit in communication with the rack sensing component and the washing mechanism. The rack sensing component may be configured to determine whether the rack is in the washing location and to provide a signal in response thereto. The processing unit may be configured to receive the signal and to prevent a washing procedure of the dishwasher when the signal indicates that the rack is not disposed in the washing location.

In yet another aspect, a method of controlling a dishwasher is provided. The method includes determining whether a rack is in a washing location in a dishwasher and providing a signal in response thereto. A washing procedure of the dishwasher may be prevented when the signal indicates that the rack is not disposed in the washing location.

In still another aspect, a safety arrangement for a dishwasher is provided. The dishwasher may include a tub portion sealable by a door pivotably engaged therewith, and may include a rack disposed about a lower end of the tub portion and a control device configured to actuate a wash cycle in the dishwasher. The safety arrangement may include an actuation device operably engaged with the dishwasher and configured to interact with the rack. The actuation device may be further configured to be in communication with the control device so as to direct the control device to prevent actuation of the wash cycle in the dishwasher upon the actuation device determining that the rack is not present in the tub portion.

### BRIEF DESCRIPTION OF THE SEVERAL VIEWS OF THE DRAWING(S)

Reference will be made to the accompanying drawings, which are not necessarily drawn to scale, and wherein:

FIG. 1 is a perspective view of a dishwasher configured in accordance with an example embodiment;

FIG. 2 is a perspective view of the dishwasher of FIG. 1 with the door open and the rack removed;

FIGS. 3A and 3B are block diagrams of dishwashers configured in accordance with respective example embodiments, each dishwasher including a safety arrangement and a control device;

FIG. 4 is a block diagram of a dishwasher configured in accordance with another example embodiment;

FIG. 5 is a perspective schematic view of a washing mechanism for a dishwasher configured in accordance with an example embodiment;

FIG. 6A is a block diagram of a circuit including a safety arrangement configured in accordance with an example embodiment, the safety arrangement including a switch in an open position;

FIG. 6B is a magnified perspective view of the switch of FIG. 6A;

FIG. 7A is a block diagram of the circuit of FIG. 6A with the switch in a closed position;

FIG. 7B is a magnified perspective view of the switch of FIG. 7A;

FIG. 8A is a block diagram of a circuit including a safety arrangement configured in accordance with an example embodiment, the safety arrangement including a pair of contacts;

FIG. 8B is a magnified perspective view of the contacts of FIG. 8A;

FIG. 9A is a block diagram of the circuit of FIG. 8A with the contacts bridged by a wire of a rack engaged by the safety arrangement;

FIG. 9B is a magnified perspective view of the contacts being bridged by the wire of a rack engaged by the safety arrangement;

FIG. 10A is a side view of a safety arrangement for a dishwasher, the safety arrangement including a switch that is protected by a guard member;

FIG. 10B is a magnified perspective view of the switch and guard member of FIG. 10A;

FIG. 11A is a block diagram of a circuit including a safety arrangement configured in accordance with an example embodiment, the safety arrangement including a complete optical link;

FIG. 11B is a perspective view of a dishwasher incorporating the optical link of FIG. 11A;

FIG. 12A is a block diagram of the circuit of FIG. 11A with the optical link disrupted; and

FIG. 12B is a perspective view of the optical link of FIG. 12A.

### DETAILED DESCRIPTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

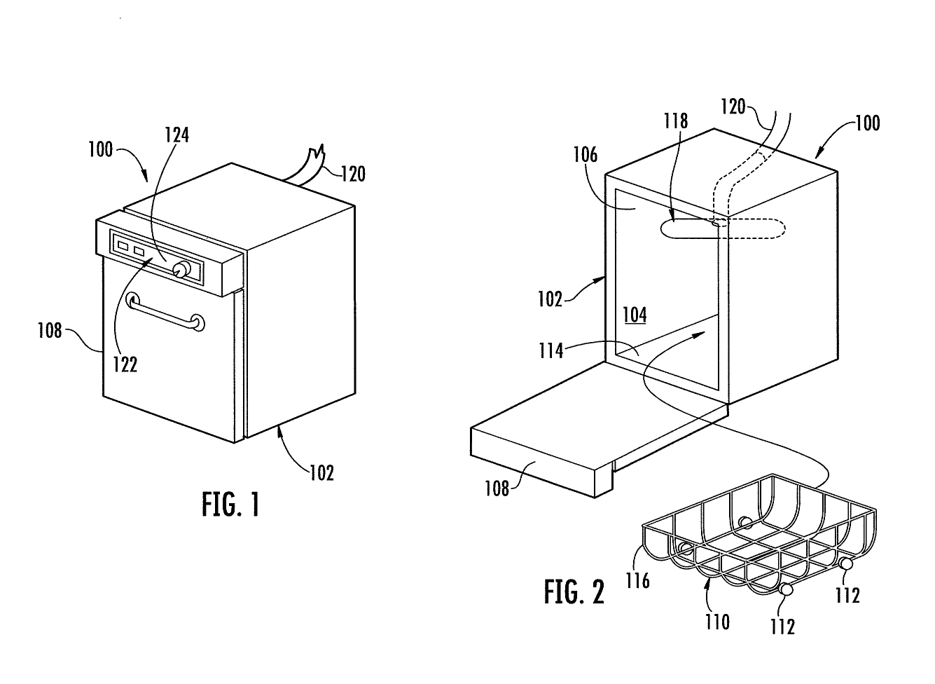

Referring to FIGS. 1 and 2, therein are shown views of a dishwasher 100 configured in accordance with an example embodiment. The dishwasher 100 includes a washing chamber 102 defining therein a washing location 104. The washing chamber 102 may include a tub portion 106 sealable by a door 108 pivotably engaged therewith. A rack 110 may be disposed within and selectively removable from the washing chamber 102. For example, the rack 110 may sit on wheels 112 that roll along the floor 114 of the tub portion 106 and the washing location 104 may be disposed at a lower end portion of the tub portion. The rack 110 may be formed of an array of wire 116 that is configured to allow the rack to hold items while allowing liquids to flow therethrough. The dishwasher 100 may also include a washing mechanism 118 configured to dispense fluid into the washing chamber 102. For example, the washing mechanism 118 may be coupled to a water supply line 120 and configured to dispense water throughout the washing chamber 102.

The dishwasher 100 may also include a control device 122, for example, integrated into or otherwise coupled to the door 108. As discussed further below, a user may utilize the control device 122 to actuate a wash cycle or otherwise initiate and/or control a washing procedure of the dishwasher 100. When a washing procedure is initiated, the washing mechanism 118 may direct water from the water supply line 120 into the washing chamber 102.

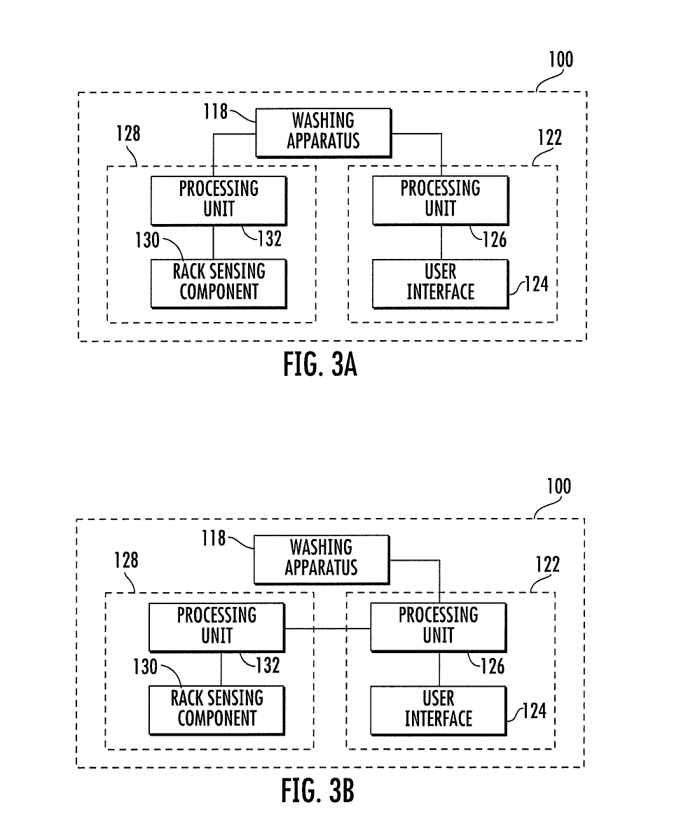

Referring to FIGS. 1, 2, 3A, and 3B, the control device 122 can include a user interface 124 and a processing unit 126 that communicate therebetween and allow a user to enter commands, such as, for example, initiating a washing procedure to be carried out by the washing mechanism 118. The dishwasher 100 may also include a safety arrangement 128, for example, coupled to or integrated with the washing chamber 102. The safety arrangement 128 may include a rack sensing component 130 configured to determine whether the rack 110 is in the washing location 104 and to provide a signal in response thereto. Non-limiting examples of possible configurations for the rack sensing component 130 are provided below. The rack sensing component 130 may be in communication with a processing unit 132, which may be configured to receive the signal from the rack sensing component and to prevent the washing procedure of the dishwasher 100 when the signal indicates that the rack 110 is not disposed in the washing location 104. The safety arrangement 128 may be in communication with the control device 122 (as shown in FIG. 3A) or may be in direct communication with the washing mechanism 118 (as shown in FIG. 3B). In addition, in some embodiments, the processing unit 126 and the processing unit 132 may be integrated (see FIG. 4). Additionally, in response to the signal from the rack sensing component 130, indicia of the rack 110 not being disposed in the washing location 104 may be provided via the user interface 124.

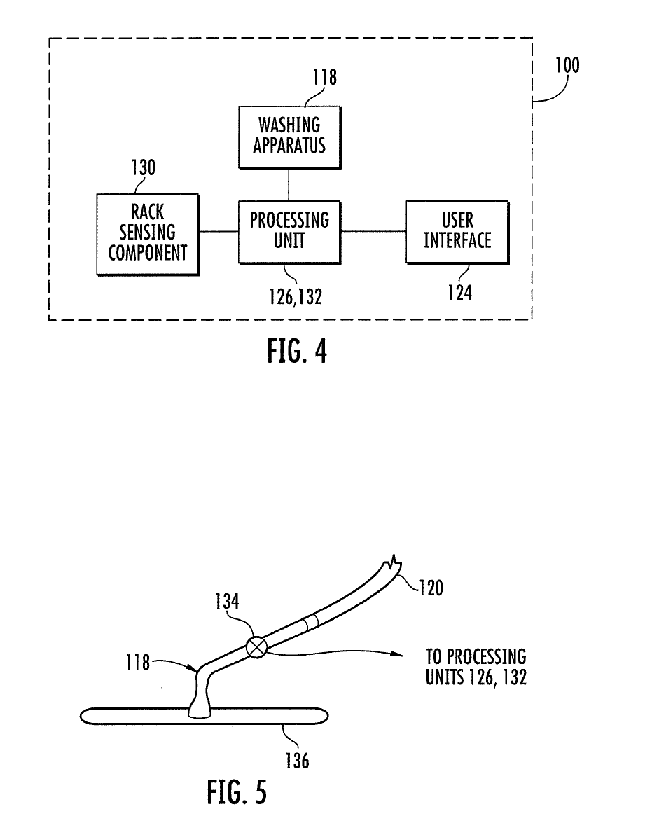

Referring to FIG. 5, the washing mechanism 118 may include an automatically actuable water inlet valve 134 configured to communicate with one or both of the processing units 126, 132. The processing unit 132 can be configured to prevent opening of the water inlet valve 134 when the rack sensing component 130 provides a signal indicating that the rack 110 is not disposed in the washing location 104. Alternatively, the processing unit 132 may be configured to inform the control device 122 when the rack sensing component 130 provides a signal indicating that the rack 110 is not disposed in the washing location 104, such that the control device might prevent opening of the water inlet valve 134, render the user interface 124 inoperable, and/or prevent power from being transmitted to one or more electrical components of the dishwasher 100, thereby preventing operation. In either case, a washing procedure may be prevented when the rack 110 is not present to block a child's access to the washing chamber 102.

Referring to FIGS. 1 and 3B, the rack sensing component 130 can be configured in any number of ways that facilitates detection of the presence and/or absence of the rack 110 with respect to the washing location 104. For example, referring to FIGS. 1, 6A, 6B, 7A, 7B, 8A, 8B, 9A, and 9B, the rack sensing component 130 may be configured to physically engage the rack 110 when the rack is disposed at the washing location 104, for instance, where the rack sensing component defines an incomplete electrical circuit 138 that is caused to be physically completed by the rack when the rack is disposed in the washing location.

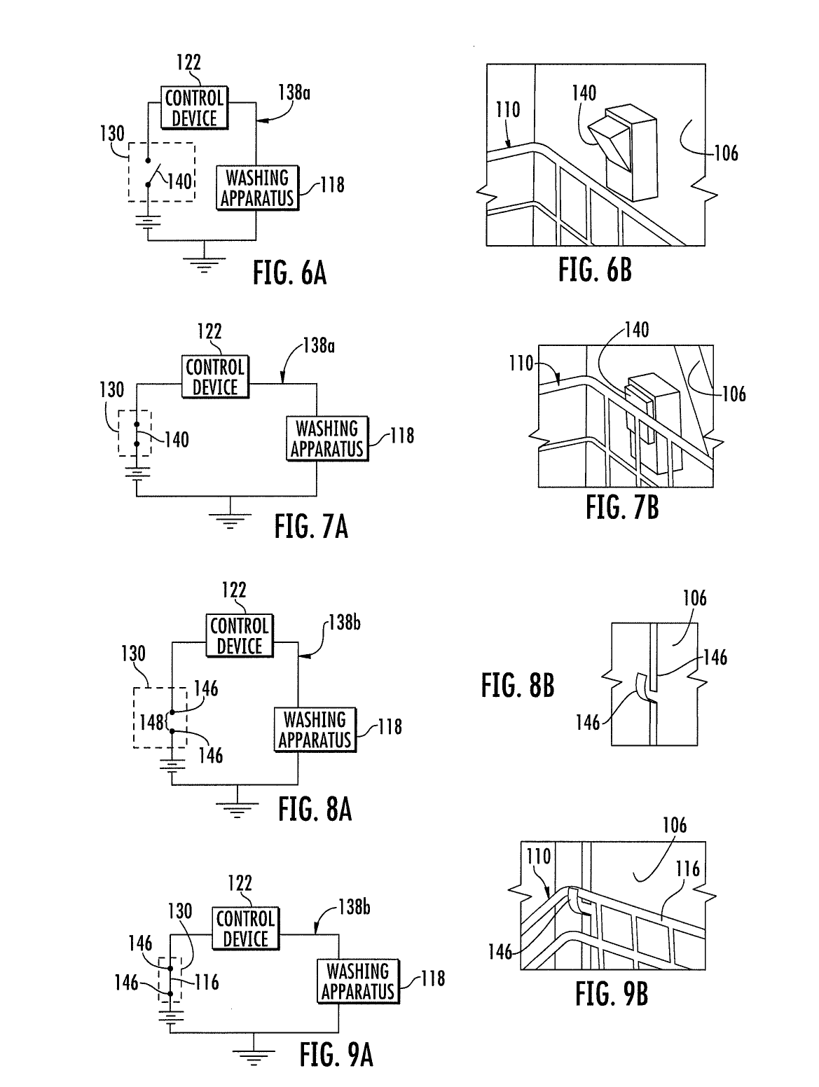

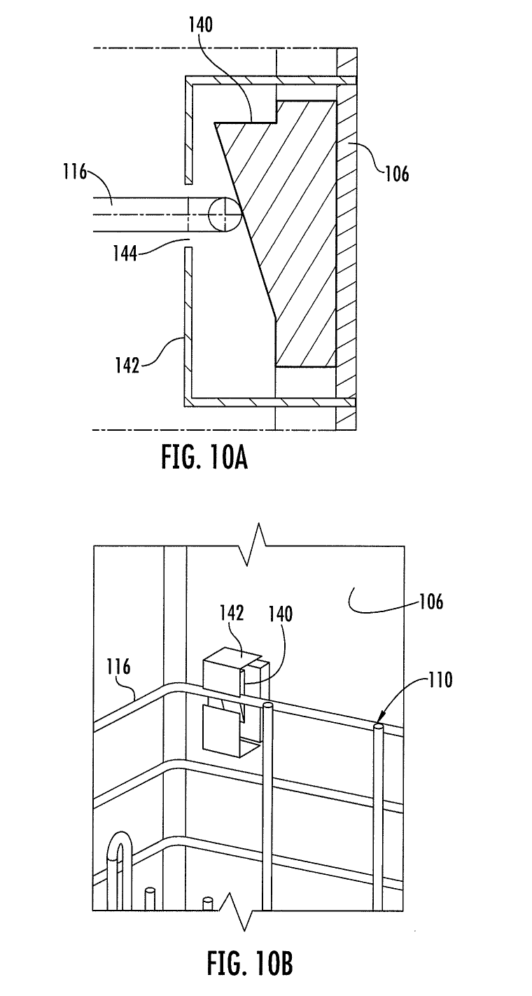

Referring to FIGS. 1, 2, 6A, 6B, 7A, and 7B, in one embodiment, the rack sensing component 130 may include an actuation device, such as a switch 140, capable of being urged into a closed position in order to complete the electrical circuit 138a. The rack 110 may then act to urge the switch 140 into the closed position (thereby completing the circuit) when the rack is disposed in the washing location 104 (see FIGS. 7A and 7B), the switch otherwise being in the open position when the rack is not in the washing location (see FIGS. 6A and 6B). As such, when the rack 110 is removed from the washing location 104, the switch 140 may be in an “open” state, thereby resulting in an open circuit preventing operation of the dishwasher 100. When the rack 110 is fully inserted into the washing chamber 102 of the dishwasher 100, the rack (or, a portion of the wire 116 forming the rack) engages the switch 140, and causes the switch to change to a “closed” state so as to complete a circuit and allow operation of the unit. In some instances, the switch 140 may have a guard member 142 extending at least partially thereabout (see FIGS. 10A and 10B). The guard member 142 may be configured to define a minimal opening 144 that allows the wire 116 of the rack 110 to pass therethrough to interact with the switch 140 while preventing access to the switch by a child, such that the child within the dishwasher cannot accidentally interact with the switch to cause a “closed” state.

Referring to FIGS. 1, 8A, 8B, 9A, and 9B, in another embodiment, the rack sensing component 130 may include an electrical circuit 138b having two contacts 146 separated by an open area 148. When the rack 110 is disposed in the washing location 104, the wire 116 of the rack 110 may act to bridge the open area 148 and complete the circuit 138b. Completion of the circuit 138b would thus enable operation of the dishwasher 100, the operation otherwise being disabled when the rack 110 is not disposed in the washing location 104.

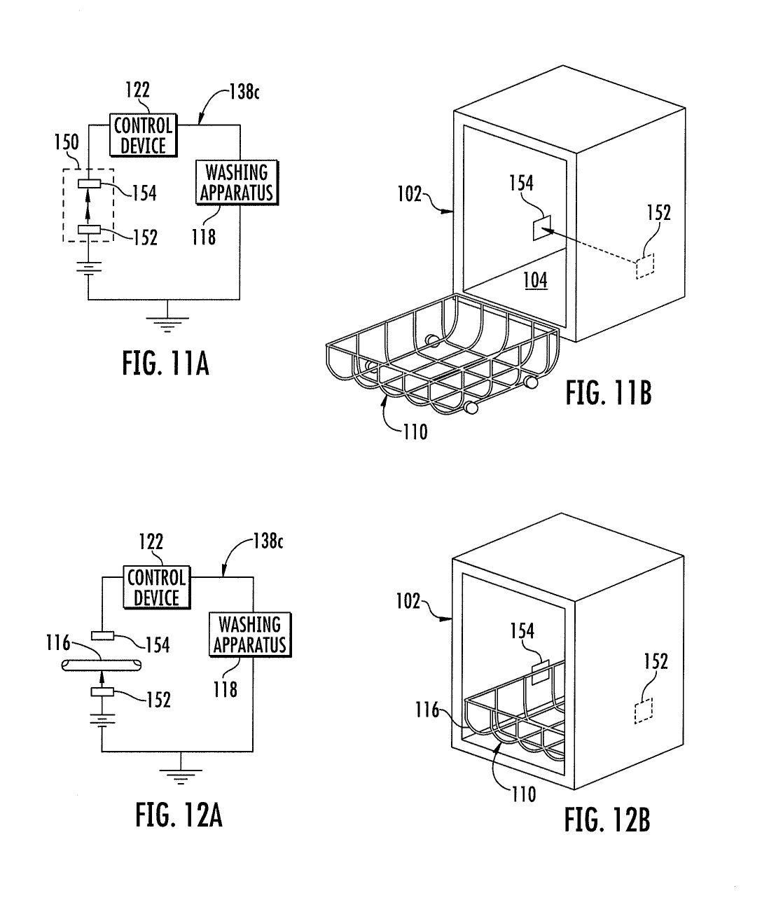

Referring to FIGS. 11A, 11B, 12A, and 12B, as another example, the rack sensing component 130 may include a detection device, such as an optical link 150, configured to detect the disposition of the rack 110 with respect to the washing location 104. The optical link 150 may include opposing optical emitter 152 and receiver 154 (e.g., a photoelectric sensor). When the rack 110 is disposed in the washing location 104 (e.g., as in FIG. 12B), the rack obstructs the optical path between the emitter 152 and the receiver 154 and the electrical circuit 138c is rendered incomplete (as shown in FIG. 12A). Otherwise, when the rack 110 is not disposed in the washing location (e.g., as in FIG. 11B), the optical link 150 remains completed, such that optical signals emitted by the emitter 152 can be received by the receiver 154. The control device 122 may thus be appropriately configured with respect to the optical link 150 in communication therewith so as to allow operation of the dishwasher 100 when the rack 110 is disposed in the washing location 104. Other types of detection devices for detecting the presence of the rack 110 in the washing location 104 may include, for example, capacitive sensors, inductive sensors, ultrasonic sensors, or any other appropriate types of sensors.

Many modifications and other embodiments of the inventions set forth herein will come to mind to one skilled in the art to which these inventions pertain having the benefit of the teachings presented in the foregoing descriptions and the associated drawings. For example, while the above described embodiments have focused on situations in which a detection device was engaged with the tub portion of the dishwasher and configured to interact with a component of the lower rack, in the alternative, the detection device may be engaged with the lower rack and configured to interact with a component of the tub portion. Further, the rack sensing concept disclosed herein may be extended, in some instances, to any suitable detection device operably engaged with the dishwasher, in or about the lower portion of the washing chamber of a dishwasher, for sensing the presence/absence of the rack and/or proximity of the rack with respect to the dishwasher. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A safety arrangement for a dishwasher, said safety arrangement comprising:
a rack sensing component configured to determine whether a rack is in a washing location in a dishwasher and to provide a signal in response thereto; and
a processing unit in communication with said rack sensing component and configured to receive the signal, the processing unit being further configured to prevent a washing procedure of the dishwasher when the signal indicates that the rack is not disposed in the washing location.

2. The safety arrangement according to claim 1, wherein said dishwasher includes a water inlet valve in communication with the processing unit, and said processing unit is configured to prevent opening of a water inlet valve when the signal indicates that the rack is not disposed in the washing location.

3. The safety arrangement according to claim 1, wherein said dishwasher further comprises a user interface in communication with the processing unit, the user interface being configured to provide an indicia of the rack not being disposed in the washing location in response to the signal.

4. The safety arrangement according to claim 1, wherein said dishwasher further comprises a user interface in communication with the processing unit, and said processing unit is configured to render the user interface inoperable when the signal indicates that the rack is not disposed in the washing location.

5. The safety arrangement according to claim 1, wherein said rack sensing component is configured to physically engage the rack when the rack is disposed at the washing location, such that said determination includes said rack sensing component sensing physical engagement with said rack.

6. The safety arrangement according to claim 5, wherein said rack sensing component defines an incomplete electrical circuit configured to be completed by the rack when the rack is disposed in the washing location.

7. The safety arrangement according to claim 6, wherein said rack sensing component includes a switch capable of being urged into a closed position to complete said electrical circuit, and said switch is configured to be urged into the closed position by the rack when the rack is disposed in the washing location.

8. The safety arrangement according to claim 1, wherein said rack sensing component comprises a detection device configured to detect said rack and a disposition thereof with respect to the washing location.

9. A dishwasher comprising:
a washing chamber defining therein a washing location;
a rack disposed within and selectively removable from said washing chamber;
a washing mechanism configured to dispense fluid into said washing chamber; and
a safety arrangement including:
a rack sensing component configured to determine whether a rack is in a washing location in a dishwasher and to provide a signal in response thereto; and
a processing unit in communication with said rack sensing component and said washing mechanism, and configured to receive the signal, said processing unit being further configured to prevent a washing procedure of the dishwasher when the signal indicates that the rack is not disposed in the washing location.

10. The dishwasher according to claim 9, wherein said washing mechanism further comprises a water inlet valve, and said processing unit is configured to prevent opening of said water inlet valve when the signal indicates that the rack is not disposed in the washing location.

11. The dishwasher according to claim 9, further comprising a user interface in communication with the processing unit and configured to provide an indicia of the rack not being disposed in the washing location in response to the signal.

12. The dishwasher according to claim 9, further comprising a user interface in communication with the processing unit, wherein said processing unit is configured to render the user interface inoperable when the signal indicates that the rack is not disposed in the washing location.

13. The dishwasher according to claim 9, wherein said rack sensing component is configured to physically engage said rack when said rack is disposed at the washing location, such that said determination includes said rack sensing component sensing physical engagement with said rack.

14. The dishwasher according to claim 13, wherein said rack sensing component defines an incomplete electrical circuit and said rack acts to complete the circuit when said rack is disposed in the washing location.

15. The dishwasher according to claim 14, wherein said rack sensing component includes a switch capable of being urged into a closed position in order to complete said electrical circuit, and said rack acts to urge said switch into the closed position when said rack is disposed in the washing location.

16. The dishwasher according to claim 9, wherein said rack sensing component comprises a detection device configured to detect said rack and a disposition thereof with respect to the washing location.

17. A method of controlling a dishwasher, comprising:
determining whether a rack is in a washing location in a dishwasher and providing a signal in response thereto; and
preventing a washing procedure of the dishwasher when the signal indicates that the rack is not disposed in the washing location.

18. The method according to claim 17, wherein preventing the washing procedure further comprises preventing opening of a water inlet valve engaged with the dishwasher when the signal indicates that the rack is not disposed in the washing location.

19. The method according to claim 17, further comprising providing an indicia of the rack not being disposed in the washing location, in response to the signal, via a user interface of the dishwasher.

20. The method according to claim 17, wherein the dishwasher further includes a user interface, and the method further comprises rendering the user interface inoperable when the signal indicates that the rack is not disposed in the washing location.

21. The method according to claim 17, wherein the dishwasher further comprises a rack sensing component, and determining whether a rack is in a washing location further comprises physically engaging said rack with the rack sensing component when said rack is disposed at the washing location, such that said determination includes said rack sensing component sensing physical engagement with said rack.

22. The method according to claim 21, wherein said rack sensing component defines an incomplete electrical circuit, and determining whether a rack is in a washing location further comprises completing the circuit when said rack is disposed in the washing location.

23. The method according to claim 22, wherein said rack sensing component includes a switch capable of being urged into a closed position in order to complete said electrical circuit, and determining whether a rack is in a washing location further comprises urging said switch into the closed position when said rack is disposed in the washing location.

24. The method according to claim 17, wherein the dishwasher further comprises a rack sensing component comprising a detection device, and the method further comprises detecting said rack and a disposition thereof with respect to the washing location.

25. A safety arrangement for a dishwasher, the dishwasher having a tub portion sealable by a door pivotably engaged therewith, and including a rack disposed about a lower end of the tub portion and a control device configured to actuate a wash cycle in the dishwasher, the safety arrangement comprising:
an actuation device operably engaged with the dishwasher and configured to interact with the rack, the actuation device being further configured to be in communication with the control device so as to direct the control device to prevent actuation of the wash cycle in the dishwasher upon the actuation device determining that the rack is not present in the tub portion.
